(19) United States
(12) Patent Application Publication
(10) Pub. No.: US 2016/0322142 A1
(43) Pub. Date: Nov. 3, 2016

(54) DEVELOPMENT OF NANOCRYSTALLINE MAGNESIUM FERRITES AND METHODS FOR PREPARING SAME FROM STEEL ROLLING MILL BY-PRODUCT MILLSCALE

(71) Applicant: SABIC GLOBAL TECHNOLOGIES B.V., Amsterdam (NL)

(72) Inventors: Fazal-ur-Rehman Awan, Al-Jubail (SA); Mahmoud Mohamed Hessien, Taif (SA); Hesham Hanafy, Al-Jubail (SA)

(21) Appl. No.: 15/108,454

(22) PCT Filed: Jan. 13, 2015
(86) PCT No.: PCT/IB2015/050251

§ 371 Date: Jun. 27, 2016

Related U.S. Application Data
(60) Provisional application No. 61/928,689, filed on Jan. 17, 2014.

(51) Int. Cl. H01F 1/34; C04B 35/626; C04B 35/622; C01G 49/00

(52) U.S. Cl. CPC H01F 1/344; C01G 49/0036; C04B 35/62645; C04B 35/62204; C01P 2006/42; C01P 2004/61; C04B 2235/3274; C04B 2235/656

(57) ABSTRACT

Method for preparing soft cubic ferrites of a general formula MFe₂O₄ comprising the steps of contacting an iron source comprising metallic iron and/or an oxide of Fe(II), Fe(III), Fe(II/III) and a metal oxide of the general formula MₓO_{y}, to form a mixture, wherein the initial stoichiometric ratio of M to iron is in the range from greater than zero to about 2, and wherein M is nickel, magnesium, zinc, or a combination thereof; and calcining the mixture at a temperature range of from about 1000° C. to about 1500° C. in a static air atmosphere, to form a soft cubic ferrite of a general formula MFe₂O₄, wherein the mixture is not subjected to an oxidation step prior to calcining.

### BACKGROUND

1. Technical Field

The present disclosure relates to magnesium ferrite materials and to methods for the preparation thereof.

2. Technical Background

Ferromagnetic oxides, or ferrites as they are frequently known, can be useful as high-frequency magnetic materials due to their large resistivities. Ferrites have become available as practical magnetic materials over the course of the last twenty years. Such ferrites are frequently used in communication and electronic engineering applications and they can embrace a very wide diversity of compositions and properties. Ferrites are ceramic materials, typically dark grey or black in appearance and very hard or brittle. Ferrite cores can be used in electronic inductors, transformers, and electromagnets where high electrical resistance leads to low eddy current losses. Early computer memories stored data in the residual magnetic fields of ferrite cores, which were assembled into arrays of core memory. Ferrite powders can be used in the coatings of magnetic recording tapes. Ferrite particles can be used as a component of radar-absorbing materials in stealth aircrafts and in the expensive absorption tiles lining the rooms used for electromagnetic compatibility measurements. Moreover, common radio magnets, including those used in loudspeakers, can be ferrite magnets. Due to their price and relatively high output, ferrite materials can also be used for electromagnetic instrument pickups.

There are basically two varieties of ferrite: soft (cubic ferrites) and hard (hexagonal ferrites) magnetic applications. Soft ferrites are characterized by the chemical formula MOFe₂O₃, with M being a transition metal element, e.g. iron, nickel, manganese or zinc. Hard ferrites are permanent magnetic materials based on the crystallographic phases BaFe₁₂O₁₉, SrFe₁₂O₁₉, and PbFe₁₂O₁₉. The formulas for these hard ferrite materials can generally be written as MFe₁₂O₁₉, where M can be Ba, Sr, or Pb. The soft ferrites belong to an important class of magnetic materials because of their remarkable magnetic properties particularly in the radio frequency region, physical flexibility, high electrical resistivity, mechanical hardness, and chemical stability.

Soft ferromagnetic oxides (ferrites) can be useful as high-frequency magnetic materials. The general formula for these compounds is MOFe₂O₃ or MFe₂O₄, where M can be a divalent metallic ion such as Fe²⁺, Ni²⁺, cu²⁺, Mg²⁺, Mn²⁺, Zn²⁺, or a mixture thereof. Soft ferrites can be useful in a broad range of electronic applications in including television deflection yokes and flyback transformers, rotary transformers in video players and recorders, switch-mode power supplies, EMI-RFI (Electromagnetic Interference and Radio Frequency Interference) absorbing materials, and a wide variety of transformers, filters and inductors in electronic home appliances and industrial equipment. A soft ferrite core can exhibit high magnetic permeability which concentrates and reinforces the magnetic field and high electrical resistivity, thus limiting the amount of electric current flowing in the ferrite. Many telecommunication parts, power conversion and interference suppression devices use soft ferrites. Frequently used combinations include manganese and zinc (MnZn) or nickel and zinc (NiZn). These compounds exhibit good magnetic properties below a certain temperature, called the Curie Temperature (Tc). They can easily be magnetized and have a rather high intrinsic resistivity.

Accordingly, there is an ongoing need for new, economical, environmentally friendly, and effective ferrite materials and methods for preparing such ferrite materials. Thus, there is a need to address these and other shortcomings associated with ferrite materials. These needs and other needs are satisfied by the compositions and methods of the present disclosure.

### SUMMARY

In accordance with the purpose(s) of the invention, as embodied and broadly described herein, this disclosure, in one aspect, relates to nickel ferrite materials and methods for the preparation thereof.

In one aspect, the present disclosure provides a method for preparing a soft cubic ferrite having the general formula MFe₂O₄, the method comprising contacting an iron source comprising a metallic iron and/or an oxide of Fe(II), Fe(III), Fe(II/III), or a combination thereof; and a metal oxide having the general formula MₓO_{y}, such that the initial stoichiometric ratio of M to iron is in the range of from greater than zero to about 2, and wherein M comprises nickel, magnesium, zinc, or a combination thereof to form a mixture; and then calcining the mixture at a temperature of from about 1,000° C. to about 1,500° C. in a static air atmosphere to form a soft cubic ferrite of having the general formula MFe₂O₄, wherein the mixture is not subjected to an oxidation step prior to calcining.

In another aspect, the present disclosure provides a method as described above, wherein the iron source comprises mill scale.

In another aspect, the present disclosure provides methods for preparing magnesium ferrites wherein an iron source comprises mill scale.

In another aspect, the present disclosure provides magnesium ferrite materials prepared by the methods described herein.

In yet another aspect, the present disclosure provides articles and/or devices comprising the magnesium ferrite materials described herein.

### BRIEF DESCRIPTION OF THE FIGURES

The accompanying figures, which are incorporated in and constitute a part of this specification, illustrate several aspects and together with the description serve to explain the principles of the invention.

FIG. 1 illustrates the X-Ray diffraction (XRD) pattern for a MgFe₂O₄ powder prepared with a molar ratio of Mg:Fe of 0.5.

FIG. 2 illustrates the XRD pattern for a MgFe₂O₄ powder prepared with a molar ratio of Mg:Fe of 0.55.

FIG. 3 illustrates the XRD pattern for a MgFe₂O₄ powder prepared with a molar ratio of Mg:Fe of 0.65.

FIG. 4 illustrates scanning electron micrographs (SEM) of nanocrystalline MgFe₂O₄ powders prepared with molar ratios of Mg:Fe and annealing temperatures of: a) 0.5 and 1,200° C.; b) 0.5 and 1,300° C.; c) 0.65 and 1,200° C.; and d) 0.65 and 1,300° C.

FIG. 5 illustrates the effect of annealing temperature on the M-H hysteresis loop of a MgFe₂O₄ powder produced at a molar ratio of Mg:Fe of 0.5.

FIG. 6 illustrates the effect of annealing temperature on the M-H hysteresis loop of a MgFe₂O₄ powder produced at a molar ratio of Mg:Fe of 0.55.

FIG. 7 illustrates the effect of annealing temperature on the M-H hysteresis loop of a MgFe₂O₄ powder produced at a molar ratio of Mg:Fe of 0.65.

FIG. 8 illustrates the saturation magnetization as a function of annealing temperature of MgFe₅O₈ for Mg:Fe of 0.5, 0.55, and 0.65, annealed for 2 hours.

FIG. 9 illustrates the saturation magnetization as a function of Mg:Fe mole ratio for an annealing temperature of 1,100° C. to 1,300° C. for 2 hours.

All publications mentioned herein are incorporated herein by reference to disclose and describe the methods and/or materials in connection with which the publications are cited.

### DEFINITIONS

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, example methods and materials are now described.

As used in the specification and the appended claims, the singular forms “a,” “an” and “the” include plural referents unless the context clearly dictates otherwise. Thus, for example, reference to “a ketone” includes mixtures of two or more ketones.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

As used herein, the terms “optional” or “optionally” means that the subsequently described event or circumstance can or can not occur, and that the description includes instances where said event or circumstance occurs and instances where it does not. For example, the phrase “optionally substituted alkyl” means that the alkyl group can or can not be substituted and that the description includes both substituted and unsubstituted alkyl groups.

Disclosed are the components to be used to prepare the compositions of the invention as well as the compositions themselves to be used within the methods disclosed herein. These and other materials are disclosed herein, and it is understood that when combinations, subsets, interactions, groups, etc. of these materials are disclosed that while specific reference of each various individual and collective combinations and permutation of these compounds can not be explicitly disclosed, each is specifically contemplated and described herein. For example, if a particular compound is disclosed and discussed and a number of modifications that can be made to a number of molecules including the compounds are discussed, specifically contemplated is each and every combination and permutation of the compound and the modifications that are possible unless specifically indicated to the contrary. Thus, if a class of molecules A, B, and C are disclosed as well as a class of molecules D, E, and F and an example of a combination molecule, A-D is disclosed, then even if each is not individually recited each is individually and collectively contemplated meaning combinations, A-E, A-F, B-D, B-E, B-F, C-D, C-E, and C-F are considered disclosed. Likewise, any subset or combination of these is also disclosed. Thus, for example, the sub-group of A-E, B-F, and C-E would be considered disclosed. This concept applies to all aspects of this application including, but not limited to, steps in methods of making and using the compositions of the invention. Thus, if there are a variety of additional steps that can be performed it is understood that each of these additional steps can be performed with any specific embodiment or combination of embodiments of the methods of the invention.

References in the specification and concluding claims to parts by weight of a particular element or component in a composition or article denote the weight relationship between the element or component and any other elements or components in the composition or article for which a part by weight is expressed. Thus, in a compound containing 2 parts by weight of component X and 5 parts by weight component Y, X and Y are present at a weight ratio of 2:5, and are present in such ratio regardless of whether additional components are contained in the compound.

A weight percent of a component, unless specifically stated to the contrary, is based on the total weight of the formulation or composition in which the component is included.

Each of the materials disclosed herein are either commercially available and/or the methods for the production thereof are known to those of skill in the art.

It is understood that the compositions disclosed herein have certain functions. Disclosed herein are certain structural requirements for performing the disclosed functions, and it is understood that there are a variety of structures that can perform the same function that are related to the disclosed structures, and that these structures will typically achieve the same result.

As briefly described above, the present disclosure provides improved soft ferrite materials and methods for the manufacture thereof. In one aspect, the methods described herein can utilize by-products from conventional steel industry processes as raw materials in the preparation of soft ferrite materials. Such by-products can contain, in various aspects, high iron content, low impurities, and/or stable chemical compositions. In another aspect, such by-products can be contacted and/or mixed with one or more other metal oxide materials and be subsequently heat treated at various temperatures. In one aspect, the methods described herein can be environmentally friendly, at least with respect to conventional ferrite production methods, by incorporating by-products from iron ore processing or steel industry processes.

Magnesium ferrites belong to the normal, or the inverse, spinel structure ferrites group. Magnesium ferrite (MgFe2O4) has a cubic spinel-type structure and is known as a soft magnetic n-type semiconductive material with high resistivity and low magnetic and dielectric losses. These materials can be used in magnetic fluids, microwaves devices, magnetic recording media, and for the fabrication of radio frequency coils, transformer cores, chock coils, noise filters, recording headings and rod antennas. In addition, magnesium ferrites can be useful in heterogeneous catalysis, adsorption and sensors.

In one aspect, the magnetic properties of a ferrite material can depend on the microstructure of the material. In another aspect, the microstructure of the ferrite can be determined by a variety of factors, such as, for example, chemical composition, raw material quality, annealing temperature, and annealing time. In another aspect, the microstructures developed during sintering are determined, to a large extent, by the material's characteristics (crystallite size and shape, size distribution, porosity, state of agglomeration, chemical and phase composition), which can be associated with the processing method.

In a steel making process, the upper layer of steel slabs can be oxidized to iron oxide prior to rolling. This oxide is called “mill scale”, and can be easily removed from the surface by a shower of water during the rolling of these slabs. This mill scale can be considered as a valuable secondary raw material due to its high iron content, low impurities and stable chemical composition. The quantity of mill scale is increasing rapidly with the current demand of increasing world steel production. The high iron content of these materials with its very low impurities makes it an excellent source for soft and hard magnets preparation via its mixing with other metal oxides and further heat treatment at various temperatures.

In one aspect, the present disclosure provides economic methods for the preparation of magnetic nano-crystalline magnesium ferrite powders. In another aspect, such methods can use a by-product or secondary source of iron oxide. In another aspect, such methods can use a magnesium oxide and a secondary iron source in various molar ratios of Fe:Mg.

In one aspect, the soft ferrite can comprise a soft ferrite, such as, for example, a nickel ferrite, a magnesium ferrite, a zinc ferrite, or a combination thereof. In one aspect, the soft ferrite can comprise a magnesium ferrite. In another aspect, one or more of the raw materials used in the preparation of a soft ferrite can comprise a by-product of a steel making process, such as, for example, mill scale.

The raw materials for preparing a soft ferrite material can comprise or be prepared from an iron oxide, such as for example, mill scale and a metal oxide, such as, for example, a magnesium oxide. In one aspect, the soft ferrite material comprises or can be prepared from mill scale and a magnesium oxide. In still other aspects, the magnesium oxide can initially be provided in a form other than the oxide, such that the magnesium containing compound can be converted to an oxide prior to or during formation of the desired ferrite material.

In one aspect, the iron containing by-product can comprise any suitable iron containing material. In another aspect, the by-product can exhibit an iron content of at least about 50 wt. %, at least about 60 wt. %, at least about 70 wt. %, or greater. In other aspects, the by-product does not contain significant concentrations of impurities that might adversely affect the preparation of a ferrite or the resulting ferrite material. In one aspect, an iron containing by-product can comprise an iron oxide dust, mill scale, bag house dust, or a combination thereof. Exemplary chemical compositions of such by-products are detailed in Table 1, below. In other aspects, the iron containing by-product can comprise other compositions typical in the steel industry, for example, and not specifically recited in Table 1. In one aspect, the iron containing by-product can comprise a mil scale having a total iron concentration of about 70 wt. %. In another aspect, the iron containing by-product comprises Fe(II), Fe(III), Fe(II/III), or a combination thereof.

TABLE 1
Exemplary Chemical Compositions of Iron Containing By-Products

| | Wt. % | | | | |
|---|---|---|---|---|---|
| | Oxide fines | Oxide fines | Mill | | Bag house |
| | 0-3 mm | 3-6 mm | scale | Slurry | dust |
| Feₜₒₜ | 63.1 | 65.8 | 70.1 | 60.2 | 28.3 |
| Fe₃O₄² | 5.5 | 4.32 | 21.6 | 37.9 | 25.8 |
| Fe²⁺ | 2.6 | 0.85 | 46.5 | 12.8 | 9.1 |
| Fe¹ | | | 0.44 | 5.2 | |
| SiO₂ | 2.3 | 1.2 | 0.52 | 2.7 | 4.9 |
| CaO | 0.86 | 0.78 | 0.18 | 2.7 | 6.0 |
| MgO | 0.41 | 0.46 | 0.029 | 0.95 | 5.5 |
| Al₂O₃ | 0.81 | 0.33 | 0.084 | 1.6 | 0.84 |
| C | 0.22 | 0.06 | 0.21 | 1.8 | 1.2 |
| S | 0.05 | 0.02 | 0.02 | 0.03 | 0.45 |
| Na | | | | 0.028 | 3.6 |
| K | | | | <0.01 | 2.8 |
| Zn | | | | <0.01 | 15.8 |
| Cl⁻ | | | | 0.003 | 1.7 |
| F⁻ | | | | 0.069 | 0.0945 |
| H₂O_{crystal} [symbol] | | | | 3.0 | 2.4 |
| Loss of | | | | 8.2 | 14.2 |
| ignition | | | | | |

[symbol]

indicates data missing or illegible when filed

In another aspect, a mill scale sample can comprise a composition such as that detailed in Table 2, below.

TABLE 2
Mill Scale Composition

| Component | Conc. Wt. % |
|---|---|
| Feₜₒₜ | 70.1 |
| Fe⁺² | 46.5 |
| Fe₃O₄ | 21.6 |
| Fe⁰ (metallic) | 0.44 |
| SiO₂ | 0.52 |
| CaO | 0.18 |
| Al₂O₃ | 0.084 |
| MgO | 0.029 |
| S | 0.02 |
| C | 0.21 |

In other aspects, the particle size of an iron containing by-product can vary, depending on the source of the by-product. In various aspects, the particle size of the iron containing by-product can be about 10 mm or less, about 8 mm or less, 6 mm or less, about 5 mm or less, about 4 mm or less, or about 2 mm or less. Exemplary particle sizes are detailed in Table 3, below. It should be noted that particle sizes are typically a distributional property and that a sample having an average particle size can typically comprise a range of individual particle sizes.

TABLE 3
Exemplary Particle Distributions for Iron Containing By-Products

| Screen | Undersize, % | | | | |
|---|---|---|---|---|---|
| Size | Oxide pellet | Oxide pellet | Mill | | Bag house |
| (mm) | fines (0-3 mm) | fines (3-6 mm) | scale | Slurry | dust |
| 8.00 | | 100.00 | | | |
| 6.73 | | 99.40 | | | |
| 6.00 | 100.00 | 95.73 | 100.00 | | |
| 4.76 | 99.65 | 53.93 | 99.38 | | |
| 3.35 | 96.09 | 4.96 | 96.12 | | |
| 2.36 | 75.11 | 2.65 | 92.46 | 100.00 | |
| 1.70 | 54.62 | 2.58 | 83.93 | | |
| 1.18 | 47.36 | | 74.66 | | |
| 0.850 | 43.69 | | 65.13 | | |
| 0.600 | 40.71 | | 56.37 | | |
| 0.500 | | | | 98.69 | |
| 0.425 | 39.11 | | 47.94 | | |
| 0.300 | 37.74 | | 38.56 | | |
| 0.212 | 36.22 | | 29.52 | 96.28 | 97.75 |
| 0.150 | 34.98 | | 21.58 | 95.21 | 94.80 |
| 0.106 | | | | 93.73 | 92.94 |
| 0.075 | 32.79 | | 11.41 | 92.09 | 92.01 |
| 0.053 | | | | 90.02 | 88.60 |
| 0.044 | | | | 87.03 | 85.05 |
| 0.038 | 27.31 | | 6.42 | 84.93 | 81.01 |
| 0.020 | | | | 63.77 | 67.93 |
| 0.010 | | | | 44.68 | 61.48 |
| 0.005 | | | | 31.60 | 56.11 |
| 0.003 | | | | 23.00 | 49.66 |
| 0.002 | | | | 16.63 | 42.41 |
| 0.001 | | | | 7.21 | 26.67 |
| 0.0005 | | | | 1.56 | 11.49 |

Each of the one or more metal oxide components can comprise any metal oxide suitable for use in preparing a soft ferrite. In one aspect, the metal oxide can comprise a magnesium oxide. In another aspect, the metal oxide can comprise a nickel oxide. In yet another aspect, the metal oxide can comprise a zinc oxide. In another aspect, the metal oxide can comprise two or more individual metal oxides or a mixture thereof. The purity of a metal oxide can vary, provided that such a metal oxide is suitable for use in preparing a soft ferrite as described herein. In one aspect, the metal oxide is pure or substantially pure. In another aspect, the metal oxide can be analytical grade. In one aspect, the purity of a metal oxide is at least about 80%, at least about 85%, at least about 90%, at least about 95%, or greater. In another aspect, the purity of a metal oxide is at least about 96%, at least about 97%, at least about 98%, at least about 99%, at least about 99.5%, or greater.

The size and composition of a metal oxide or mixture of metal oxides can vary, for example, depending on the desired properties of the resulting soft ferrite. Metal oxides are commercially available and one of skill in the art, in possession of this disclosure, could readily select appropriate metal oxides for use in the methods described herein.

In one aspect, the ferrite composition of the present disclosure generally comprises the formula MgFe₂O₄.

In one aspect, the metal oxide, for example, magnesium oxide, and the iron containing by-product, for example, mill scale, can be contacted. In another aspect, the metal oxide and the iron containing by-product can be mixed so as to achieve a uniform or substantially uniform mixture. In one aspect, a quantity of mill scale can be contacted with a quantity of analytical grade magnesium oxide.

In another aspect, the iron containing by-product and/or the metal oxide can optionally be milled and/or ground prior to contacting. In one aspect, the mill scale sample can be finely ground prior to mixing with stoichiometric amounts of analytical grade magnesium oxide. In various aspects, magnesium oxide and iron containing mill scale fines can be contacted so as to provide a molar ratio of Mg:Fe of from about 0.4:1 to about 0.8:1, for example, about 0.4:1, 0.45:1, 0.5:1, 0.55:1, 0.6:1, 0.65:1, 0.7:1, 0.75:1, 0.8:1. In another aspect, magnesium oxide and iron containing mill scale fines can be contacted so as to provide a molar ratio of Mg:Fe of from about 0.5:1 to about 0.65:1, for example, about 0.5:1, about 0.55:1, about 0.6:1, or about 0.65:1.

After contacting, the metal oxide and iron containing by-product can be mixed, for example, in a ball mill for about a period of time, for example, about 2 hours or about 6 hours. The mixture can then be dried, for example, at about 100° C. for a period of time, for example, from about 3 hours to about 48 hours, for example, about 3, 4, 5, 8, 10, 12, 14, 16, 18, 20, 24, 28, 32, 36, 40, 44, or 48 hours, or overnight.

The mixture of metal oxide, for example, magnesium oxide, and iron containing by-product, for example, mill scale fines, can then be calcined to form a ferrite material, such as, for example, a magnesium ferrite. In one aspect, the mixture of metal oxide and iron containing by-product can be heated at a rate of about 10° C./min in a static air atmosphere up to a desired annealing temperature. In various aspects, the annealing temperature can range from about 1,000° C. to about 1,500° C., for example, about 1,000° C., about 1,100° C., about 1,200° C., about 1,300° C., about 1,400° C., or about 1,500° C. Once the desired annealing temperature is reached, the mixture can be held at the annealing temperature for a period of time, for example, about 2 hours.

In one aspect, the mixture of metal oxide and iron containing by-product is not subjected to one or more of an oxidation step or a compacting step prior to calcining. In another aspect, the mixture of metal oxide and iron containing by-product is not subjected to an oxidation step or a compacting step prior to calcining.

FIG. 1 illustrates exemplary X-Ray Diffraction (XRD) patterns for magnesium ferrites prepared from mill scale and magnesium oxide at a Mg:Fe molar ratio of 0.5, and annealed at temperatures of 1,000° C., 1,100° C., 1,200° C., and 1,300° C. for 2 hours. In one aspect, the formation of a single phase MgFe₂O₄ can be difficult to achieve due to the presence of α-Fe₂O₃ impurity.

At an annealing temperature of about 1,000° C., a single phase of MgFe₂O₄ (molar Mg:Fe ratio of 0.5:1) can be prepared containing a significant amount of α-Fe₂O₃ impurity. In one aspect, the MgFe₂O₄ phase can be present in an approximately equal amount to a hematite phase. In another aspect, at annealing temperatures greater than 1,100° C., for example, about 1,200° C. and/or 1,300° C., a decrease in the hematite phase can be observed. Similarly, the ferrite phase can increase with a corresponding increase in annealing temperature up to, for example, about 1,200° C. In another aspect, at annealing temperatures above 1,200° C., for example, about 1,300° C., the ferrite phase can decrease.

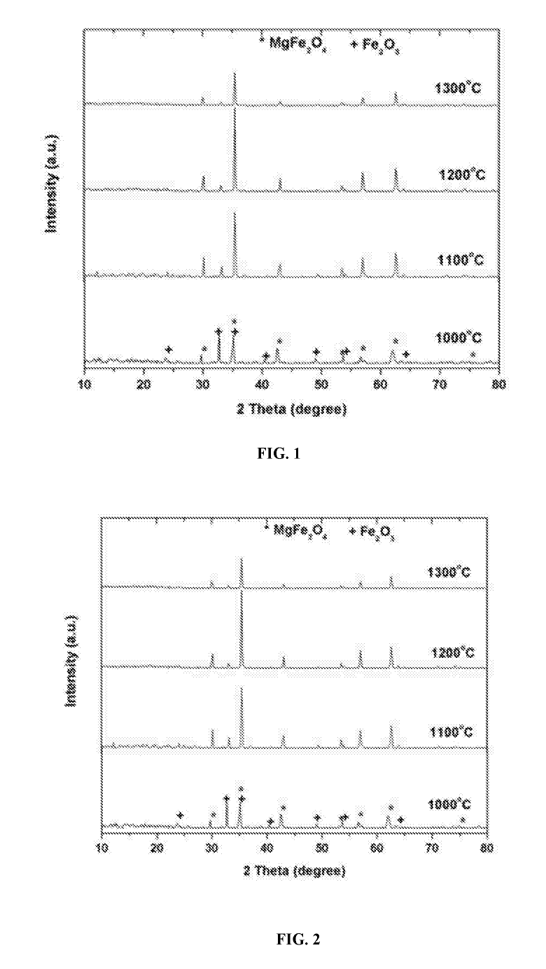

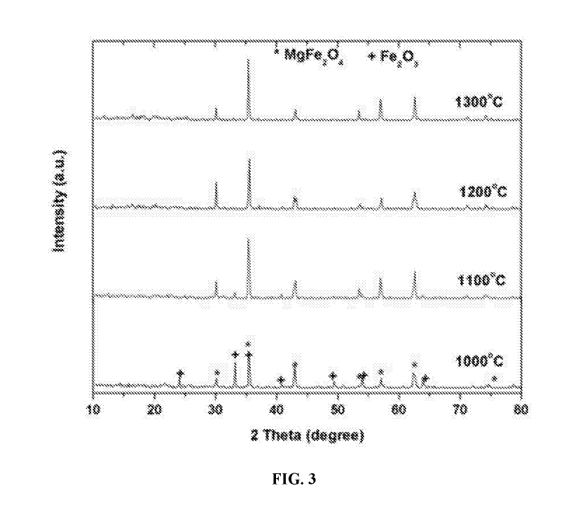

FIGS. 2 and 3 illustrate XRD patterns for magnesium ferrite materials prepared having Mg:Fe molar ratios of 0.55:1 and 0.65:1, annealed at temperatures of 1,000° C., 1,100° C., 1,200° C., and 1,300° C. for 2 hours.

At low annealing temperatures, for example, about 1,000° C., the molar ratio of Mg:Fe does not typically have a significant effect on the formation of a MgFe₂O₄ phase. In samples having a Mg:Fe molar ratio of 0.55:1, a single phase of MgFe₂O₄ can be formed under some, but not all annealing temperatures, as illustrated in FIG. 2. In samples having a Mg:Fe molar ratio of 0.65:1, a single phase of MgFe₂O₄ can be formed at annealing temperatures of 1,200° C. and 1,300° C., as illustrated in FIG. 3. In one aspect, formation of a single ferrite phase can be improved at an annealing temperature of about 1,200° C., and can be slightly decreased as the annealing temperature is raised to about 1,300° C.

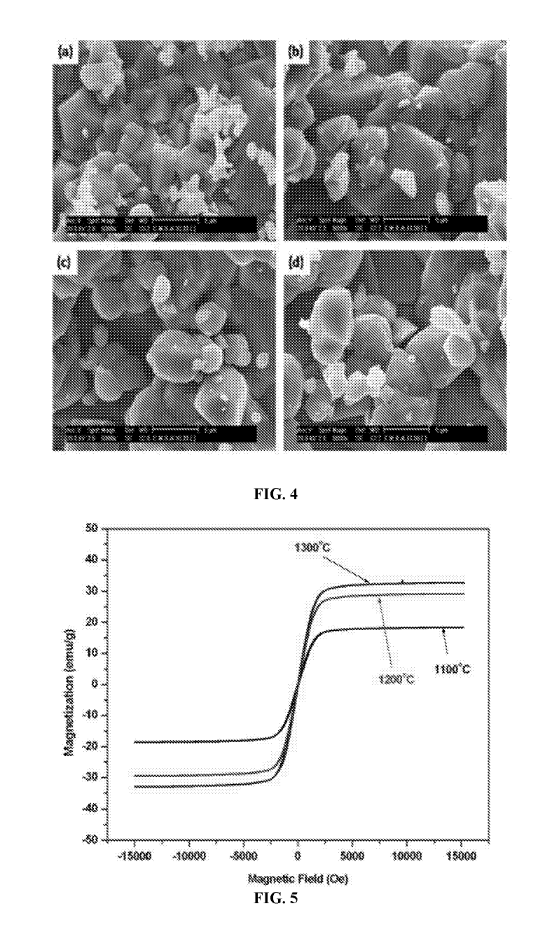

The morphology and microstructure of magnesium ferrite materials are illustrated in FIG. 4. In one aspect, an increase in grain size of the resulting ferrite material can occur as the annealing temperature is increased. In one aspect, at a Mg:Fe molar ratio of about 0.5:1 and an annealing temperature of 1,200° C., a ferrite material can exhibit an irregular microstructure with a combination of large particles and small spherical particles, ranging from 0.5 μm to 3.5 μm. In another aspect, a similar powder annealed at 1,300° C. can exhibit a uniform, coarse structure and crystalline microstructure having larger grain size and fewer small spherical particles. In such an aspect, the average grain size can be from about 1 μm to about 6 μm.

For a magnesium ferrite material having a Mg:Fe molar ratio of 0.65:1, a homogeneous microstructure can become prevalent at annealing temperatures of from about 1,200° C. to about 1,300° C., with no or relatively no small spherical particles being present. In one aspect, the average grain size for such magnesium ferrite materials can range from about 3 μm to about 6 μm.

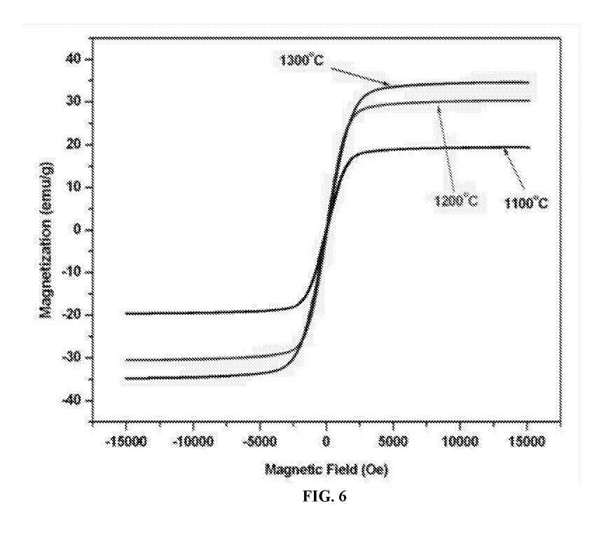

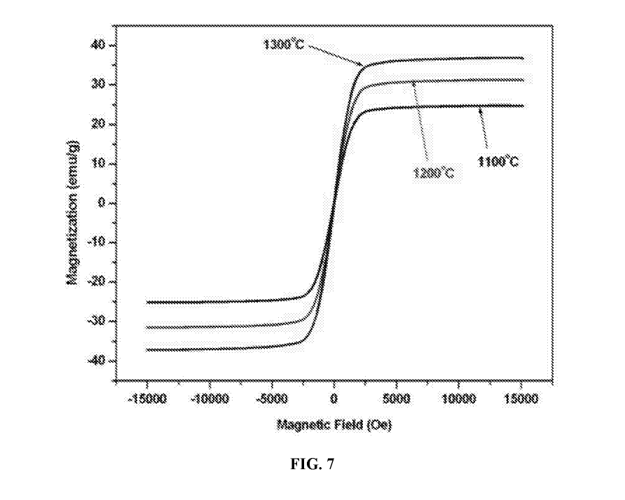

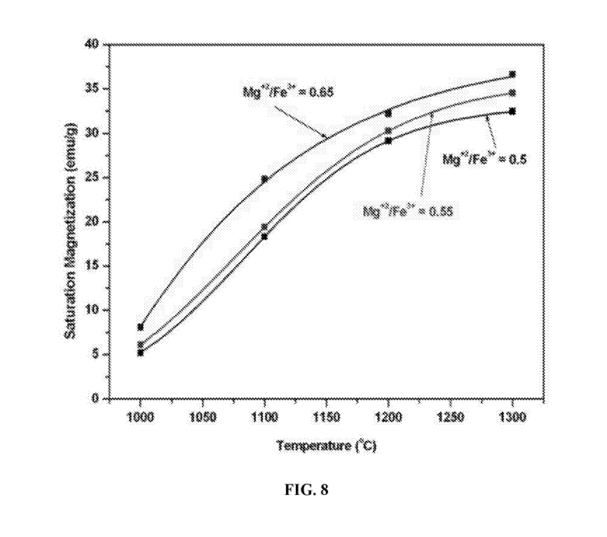

In another aspect, the resulting ferrite materials can be magnetized at room temperature under an applied field of, for example, 16 KOe, wherein hysteresis loops can be obtained. Exemplary plots of magnetization (M) as a function of the applied field (H) for the nickel zinc ferrite materials are illustrated in FIGS. 5-9. In general, a magnesium ferrite can be a soft magnetic material due to, for example, deviation from rectangular form and inherent low coercivity. In another aspect, the magnetic properties of a nickel zinc ferrite can be dependent upon, for example, the annealing temperature and/or magnesium ion concentration.

In one aspect, the saturation magnetization of a magnesium ferrite can be increased by raising the annealing temperature, for example, from about 1,100° C. to about 1,300° C. Such an increase can, in various aspects, be attributed to an increase in phase formation, grain size, and/or crystallite size.

In another aspect, magnesium ferrite powders having a Mg:Fe molar ratio of 0.65:1 and annealed at 1,300° C. for 2 h can exhibit a saturation magnetization of at least about 25 emu/g, at least about 30 emu/g, at least about 32 emu/g, at least about 34 emu/g, at least about 36 emu/g, or greater. In one aspect, magnesium ferrite powders having a Mg:Fe molar ratio of 0.65:1 and annealed at 1,300° C. for 2 h can exhibit a saturation magnetization of about 36.64 emu/g. Such high saturation magnetization for magnesium ferrites annealed at 1,300° C. can, in various aspects, be attributed to the high phase purity and well-defined crystallinity of MgFe₅O₈. FIG. 8 illustrates the increase in saturation magnetization with increasing annealing temperature from 1,100° C. to 1,300° C.

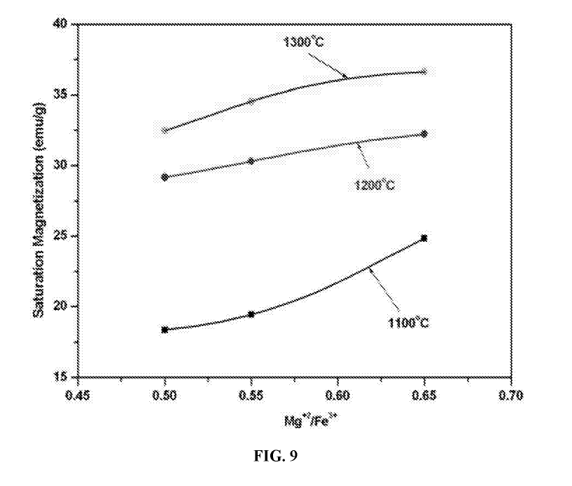

In one aspect, the increase in the saturation magnetization by increasing the annealing temperature can be due to the increase of phase purity and well-defined crystallinity of MgFe₅O₈. In another aspect, the saturation magnetization of a magnesium ferrite can increase with a corresponding increase in magnesium ion concentration up to a Mg:Fe molar ratio of about 0.65:1 at annealing temperatures of from about 1,100° C. to about 1,300° C., as illustrated in FIG. 9.

In other aspects, a ferrite of the present invention or a composition comprising a ferrite of the present invention can be used in one or more of power electronics, ferrite antennas, magnetic recording heads, magnetic intensifiers, data storage cores, filter inductors, wideband transformers, power/current transformers, magnetic regulators, driver transformers, wave filters, cable EMI, or a combination thereof. In one aspect, the inventive ferrite can comprise a core material for one or more of the devices and/or applications described above. In another aspect, an article of manufacture can comprise the ferrite of the present invention.

The methods and compositions of the present disclosure can be described in a number of exemplary and non-limiting aspects, as described below.

Aspect 1: A method for preparing a soft cubic ferrite having the general formula MFe₂O₄, the method comprising:
a) contacting:
   i. an iron source comprising a metallic iron and/or an oxide of Fe(II), Fe(III), Fe(II/III), or a combination thereof; and
   ii. a metal oxide having the general formula MₓO_{y}, such that the initial stoichiometric ratio of M to iron is in the range of from greater than zero to about 2, and wherein M comprises nickel, magnesium, zinc, or a combination thereof to form a mixture; and then
b) calcining the mixture at a temperature of from about 1,000° C. to about 1,500° C. in a static air atmosphere to form a soft cubic ferrite of having the general formula MFe₂O₄,
wherein the mixture is not subjected to an oxidation step prior to calcining.

Aspect 2: The method of aspect 1, wherein M is magnesium.

Aspect 3: The method of aspect 1, wherein the iron source comprises mill scale.

Aspect 4: The method of aspect 3, wherein the mill scale comprises one or more oxides of Fe, Fe(II), Fe(III), Fe(II/III), or a combination thereof, and wherein the mill scale further comprises from about 0.3% SiO₂ to about 1% SiO₂.

Aspect 5: The method of aspect 1, wherein the metal oxide comprises mill scale and a pure metal oxide.

Aspect 6: The method of any of aspects 1-5, wherein the mill scale comprises:
a) a total iron concentration of from about 60 wt % to about 75 wt %;
b) a Fe (II) compound in a concentration of from about 35 to 50 wt %;
c) a Fe(II/III) compound in a concentration of from about 15 wt % to about 25 wt %;
d) metallic iron in a concentration of from 0 wt % to about 1 wt %; and
e) magnesium oxide (MgO) in a concentration of from greater than 0 wt % to about 1 wt %.

Aspect 7: The method of aspect 6, wherein the mill scale comprises at least 0.029 wt % of magnesium oxide (MgO).

Aspect 8: The method of aspect 2, wherein the mole ratio of Mg/Fe is in the range of from about 0.5 to about 0.65.

Aspect 9: The method of aspect 2, wherein the mole ratio of Mg/Fe is about 0.65.

Aspect 10: The method of aspect 1, wherein the mill scale is ground to a mean particle size of about 0.074 mm.

Aspect 11: The method of aspect 1, wherein contacting is performed for at least 6 hours.

Aspect 12: The method of aspect 1, further comprising drying the mixture, after contacting and prior to calcining.

Aspect 13: The method of aspect 12, wherein drying is performed at a temperature of at least 100° C. for a period of time from about 3 to about 48 hours.

Aspect 14: The method of aspect 1, wherein calcining is performed at a temperature of at least about 1,200° C.

Aspect 15: The method of aspect 1, wherein calcining is performed at a temperature of at least about 1,300° C.

Aspect 16: The method of aspect 1, wherein calcining comprises heating at a rate of about 10° C./min.

Aspect 17: The method of aspect 1, wherein no additional oxygen or oxidant is added to the static air atmosphere.

Aspect 18: A MgFe₂O₄ ferrite prepared by any of the methods of aspects 1-17.

Aspect 19: The MgFe₂O₄ ferrite of aspect 18, wherein the MgFe₂O₄ comprises a single MgFe₂O₄ ferrite phase.

Aspect 20: The MgFe₂O₄ ferrite of aspect 19, wherein the stoichiometric ratio Mg/Fe is 0.65, and wherein the calcining temperature used to form the ferrite is at least about 1,200° C.

Aspect 21: The MgFe₂O4 ferrite of aspect 19, having a uniform size distribution with an average grain size in the range of from about 3 to about 6 μm.

Aspect 22: The MgFe₂O₄ ferrite of aspect 19, wherein the MgFe₂O₄ ferrite exhibits maximum a saturation magnetization of at least 20 emu/g.

Aspect 23: The MgFe₂O₄ ferrite of aspect 19, wherein the MgFe₂O₄ ferrite exhibits maximum a saturation magnetization of at least 25 emu/g.

Aspect 24: The MgFe₂O₄ ferrite of aspect 19, wherein the MgFe₂O₄ ferrite exhibits maximum a saturation magnetization of at least 30 emu/g.

Aspect 25: The MgFe₂O₄ ferrite of aspect 19, wherein the MgFe₂O₄ ferrite exhibits maximum a saturation magnetization of at least 35 emu/g.

Aspect 26: A composition comprising the ferrite of any of aspects 18-25.

Aspect 27: An article of manufacture comprising the ferrite of any of aspects 18-25.

Aspect 28: The composition of aspect 26 comprising core materials for power electronics, ferrite antennas, magnetic recording heads, magnetic intensifiers, cores for data storage, filter inductors, wideband transformers, power/current transformers, magnetic regulators, driver transformers, wave filters, or cable EMI.

### EXAMPLES

The following examples are put forth so as to provide those of ordinary skill in the art with a complete disclosure and description of how the compounds, compositions, articles, devices and/or methods claimed herein are made and evaluated, and are intended to be purely exemplary of the invention and are not intended to limit the scope of what the inventors regard as their invention. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

### 1. Example 1

In a first example, a mill scale sample with about 70% total iron was finely ground to an average particle size of about 0.074 mm and thoroughly mixed with a stoichiometric amount of analytical grade magnesium oxide. Mixtures of raw materials (i.e., magnesium oxide and mill scale) were prepared, such that Mg:Fe molar ratios were 0.5:1, 0.55:1, and 0.65:1. The pre-calculated stoichiometric ratios of raw materials were mixed in a ball for 6 h and then dried at 100° C. overnight. The dried precursors were calcined at a rate of 10° C./min in static air atmosphere up to the required annealed temperature and maintained at the temperature for the annealing time in the muffle furnace. The effect of annealing temperature (1,000, 1,100, 1,200, and 1,300° C.) on the formation of Mg ferrite was studied.

The crystalline phases present in the different samples were identified by X-ray diffraction (XRD) in the range 20 from 10° to 80°. The ferrites particle morphologies were observed by scanning electron microscope (SEM, JSM-5400). The magnetic properties of the ferrites were measured at room temperature using a vibrating sample magnetometer (VSM; 9600-1 LDJ, USA) in a maximum applied field of 16 kOe. From the obtained hysteresis loops, the saturation magnetization (Ms), Remnant Magnetization (Mr) and Coercivety (Hc) were determined.

### 2. Example 2

In a second example, the resulting magnesium ferrite materials were magnetized. Magnetization of the produced magnesium ferrite powders was performed at room temperature under an applied field of 16 KOe and the hysteresis loops of the ferrite powders were obtained. Plots of magnetization (M) as a function of applied field (H) per Mg:Fe mole ratio and annealing temperature were prepared.

It will be apparent to those skilled in the art that various modifications and variations can be made in the present invention without departing from the scope or spirit of the invention. Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

1. A method for preparing a soft cubic ferrite having the general formula MFe₂O₄, the method comprising:
a) contacting:
i. an iron source comprising a metallic iron and/or an oxide of Fe(II), Fe(III), Fe(II/III), or a combination thereof; and
ii. a metal oxide having the general formula MₓO_{y}, such that the initial stoichiometric ratio of M to iron is in the range of from greater than zero to about 2, and wherein M comprises nickel, magnesium, zinc, or a combination thereof to form a mixture; and then
b) calcining the mixture at a temperature of from about 1,000° C. to about 1,500° C. in a static air atmosphere to form a soft cubic ferrite of having the general formula MFe₂O₄,
wherein the mixture is not subjected to an oxidation step prior to calcining.

2. The method of claim 1, wherein M is magnesium.

3. The method of claim 1, wherein the iron source comprises mill scale.

4. The method of claim 3, wherein the mill scale comprises one or more oxides of Fe, Fe(II), Fe(III), Fe(II/III), or a combination thereof, and wherein the mill scale further comprises from about 0.3% SiO₂ to about 1% SiO₂.

5. The method of claim 1, wherein the metal oxide comprises mill scale and a pure metal oxide.

6. The method of claim 1, wherein the mill scale comprises:
f) a total iron concentration of from about 60 wt % to about 75 wt %; g) a Fe (II) compound in a concentration of from about 35 to 50 wt %;
h) a Fe(II/III) compound in a concentration of from about 15 wt % to about 25 wt %;
i) metallic iron in a concentration of from 0 wt % to about 1 wt %; and
j) magnesium oxide (MgO) in a concentration of from greater than 0 wt % to about 1 wt %.

7. The method of claim 6, wherein the mill scale comprises at least 0.029 wt % of magnesium oxide (MgO).

8. The method of claim 2, wherein the mole ratio of Mg/Fe is in the range of from about 0.5 to about 0.65 or 0.65.

9. (canceled)

10. The method of claim 1, wherein the mill scale is ground to a mean particle size of about 0.074 mm.

11. (canceled)

12. The method of claim 1, further comprising drying the mixture, after contacting and prior to calcining.

13. (canceled)

14. The method of claim 1, wherein calcining is performed at a temperature of at least about 1,200° C.

15. (canceled)

16. (canceled)

17. The method of claim 1, wherein no additional oxygen or oxidant is added to the static air atmosphere.

18. A ferrite, wherein the ferrite comprises MgFe₂O₄ ferrite prepared by the method of claim 1.

19. The MgFe₂O₄ ferrite of claim 18, wherein the MgFe₂O₄ comprises a single MgFe₂O₄ ferrite phase.

20. The MgFe₂O₄ ferrite of claim 19, wherein the stoichiometric ratio Mg/Fe is 0.65, and wherein the calcining temperature used to form the ferrite is at least about 1,200° C.

21. The MgFe₂O₄ ferrite of claim 19, having a uniform size distribution with an average grain size in the range of from about 3 to about 6 μm.

22. The MgFe₂O₄ ferrite of claim 19, wherein the MgFe₂O₄ ferrite exhibits maximum a saturation magnetization of at least 20 emu/g, at least 25 emu/g, at least 30 emu/g, or at least 35 emu/g.

23-25. (canceled)

26. A composition comprising the ferrite of claim 18.

27. An article of manufacture comprising the ferrite of claim 18.

28. The composition of claim 26 comprising core materials for power electronics, ferrite antennas, magnetic recording heads, magnetic intensifiers, cores for data storage, filter inductors, wideband transformers, power/current transformers, magnetic regulators, driver transformers, wave filters, or cable EMI.
